(19) United States
(12) Patent Application Publication
(10) Pub. No.: US 2009/0220833 A1
(43) Pub. Date: Sep. 3, 2009

(54) Fuel Cell Device

(76) Inventor: Eric T. Jones, Clarkston, MI (US)

Correspondence Address: REISING ETHINGTON P.C., P O BOX 4390, TROY, MI, 48099-4390, US

(21) Appl. No.: 12/067,504

(22) PCT Filed: Sep. 21, 2006
(86) PCT No.: PCT/US06/36641

§ 371 Date: Oct. 21, 2008

Related U.S. Application Data
(60) Provisional application No. 60/719,285, filed on Sep. 21, 2005.
(60) Provisional application No. 60/753,340, filed on Dec. 22, 2005.

(51) Int. Cl. H01M 8/04; H01M 2/02; H01M 2/08; H01M 4/88

(52) U.S. Cl. 429/22; 429/34; 429/35; 29/623.1

(57) ABSTRACT

A fuel cell device (10) for generating electricity from hydrogen and oxygen and comprising a membrane electrode assembly (MEA) (12) and a bipolar separator plate (BSP) (14) supported adjacent and generally parallel to the membrane electrode assembly. A contact array (18, 64) provides electrical contact between the MEA and the BSP. The contact array comprises a plurality of compliant electrical contacts (20) that may be partibly retained between the MEA and the BSP.

This application claims priority of U.S. provisional application Ser. No. 60/719,285, filed Sep. 21, 2005, and Ser. No. 60/753,340, filed Dec. 22, 2005.

### TECHNICAL FIELD

This invention relates generally to a fuel cell device for generating electricity from hydrogen and oxygen.

### BACKGROUND

Hydrogen fuel cells generate electricity from hydrogen and oxygen. Such fuel cells may include a stack of fuel cell modules, each module including a negative electrode (or anode) and a positive electrode (or cathode) sandwiching an electrolyte such as a proton-permeable membrane. Hydrogen is fed to the anode, and oxygen to the cathode. Hydrogen atoms separate into protons and electrons at the anode, the protons passing through the membrane to the cathode and the electrons moving along a current path to the cathode to complete an electrical circuit and create an electrical current. The protons that have migrated through the electrolyte to the cathode reunite with oxygen and the electrons in an exothermic reaction producing water. Each fuel cell module connects in series with the other modules in the stack to increase electrical potential.

It's also known for each such fuel cell module in a stack to include a membrane electrode assembly (MEA) and a bipolar separator plate (BSP). Each MEA includes a proton-permeable membrane that may be sandwiched between two current collector layers and may also include gas diffusion layers sandwiching the membrane and current collector layers. Each BSP comprises a plate of conductive material such as stainless steel or graphite and includes gas channels etched or machined in a side of the BSP that is to contact the MEA. In the stack of modules, each BSP serves as a cathode for an MEA on one side and as an anode for an MEA on the other side.

### SUMMARY OF THE DISCLOSURE

A fuel cell device (10) is provided for generating electricity from hydrogen and oxygen. The device comprises a membrane electrode assembly (12), a bipolar separator plate (14) supported adjacent and generally parallel to the membrane electrode assembly, and a contact array (18, 64) providing electrical contact between the membrane electrode assembly and the bipolar separator plate. The contact array comprises a plurality of compliant electrical contacts (20) that are partibly retained between the membrane electrode assembly and the bipolar separator plate. This allows the contact array to be easily installed during fuel cell stack (11) assembly and easily removed and/or replaced during fuel cell stack maintenance.

According to another aspect of the disclosure, a fuel cell device (10) is provided in which the contact array (18, 64) comprises a plurality of electrically-conductive resilient tubes (52, 56) disposed and providing electrical contact between the membrane electrode assembly and the bipolar separator plate.

A method is also provided for making a fuel cell. The method includes the steps of providing a membrane electrode assembly (12) and a bipolar separator plate (14), and partibly retaining a resilient contact array (18) between the membrane electrode assembly (12) and the bipolar separator plate (14).

### BRIEF DESCRIPTION OF THE DRAWINGS

These and other features and advantages will become apparent to those skilled in the art in connection with the following detailed description, drawings, photographs, and appendices, in which:

FIG. 1 is an orthogonal view of a fuel cell device constructed according to the invention;

FIG. 2 is a partial front end view of the fuel cell device of FIG. 1;

FIG. 3 is a perspective view of a gas manifold of the fuel cell device of FIG. 1;

FIG. 4 is a cross-sectional partial top view of the fuel cell device of FIG. 1 taken along line 4-4 of FIG. 2;

FIG. 5 is a cross-sectional partial end view of the fuel cell device of FIG. 1 taken along line 5-5 of FIG. 4 and showing compliant tubular electrical contacts of the device arranged on a bipolar separator plate of a module of the device and between gas manifolds of the module;

FIG. 6 is a cross-sectional partial top view of an alternative embodiment of the fuel cell device of FIG. 1 including layers of compliant tubular electrical contacts on both the anode and the cathode side of each membrane electrode assembly of each module of the fuel cell device;

FIG. 7 is a partial cross-sectional view of the alternative fuel cell device of FIG. 6 taken along line 7-7 of FIG. 6 and showing compliant tubular electrical contacts arranged on an anode side of a membrane electrode assembly of a module of the device within a gas delivery chamber of the module;

FIG. 8 is a cross-sectional partial side view of the fuel cell device of FIG. 6 taken along line 8-8 of FIG. 7 and looking lengthwise through the tubular electrical contacts disposed within gas delivery chambers of the device;

FIG. 9 is a cross-sectional partial top view of another alternative embodiment of the fuel cell device of FIG. 1 including resilient conductive mats arranged on an anode side of the membrane electrode assembly of each module of the device within the gas delivery chamber of each module;

FIG. 10 is a cross-sectional partial end view of the fuel cell device of FIG. 9 taken along line 10-10 of FIG. 9;

FIG. 11 is a cross-sectional partial side view of the fuel cell device of FIG. 9 taken along line 11-11 of FIG. 10;

FIG. 12 is a cross-sectional partial end view of an alternative embodiment of the fuel cell device of FIG. 9 including resilient conductive mats arranged in gas delivery chambers defined in part by chambers formed into the BSPs of each module of the device;

FIG. 13 is a cross-sectional partial side view of the fuel cell device of FIG. 12;

FIG. 14 is a schematic cross-sectional side view of a fuel cell device constructed according to the invention showing air being blown through the device with an outflow restrictor of the device in an open position;

FIG. 15 is a schematic cross-sectional partial side view of the fuel cell device of FIG. 14 with the outflow restrictor in a partially-closed position restricting the outflow of air from the device.

### DETAILED DESCRIPTION OF INVENTION EMBODIMENT(S)

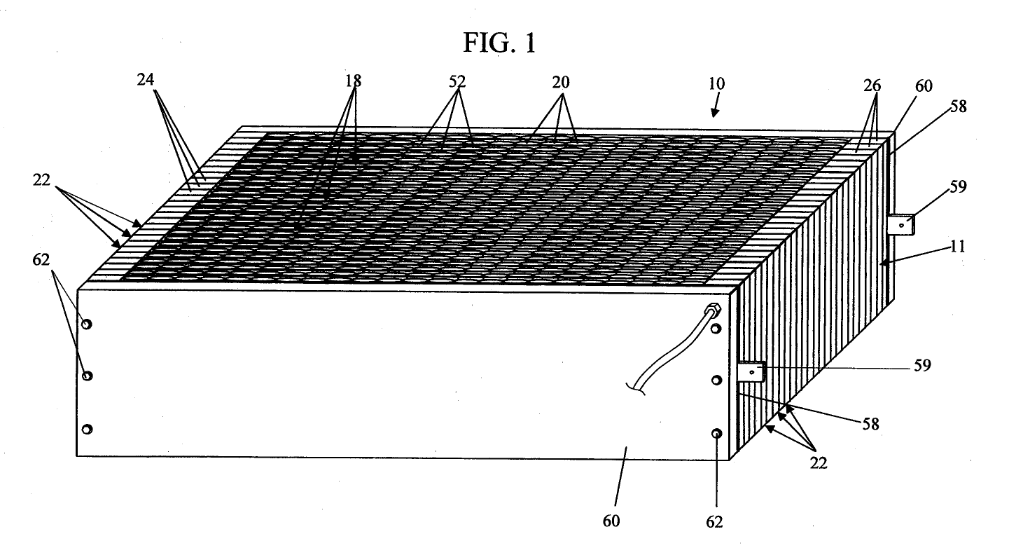

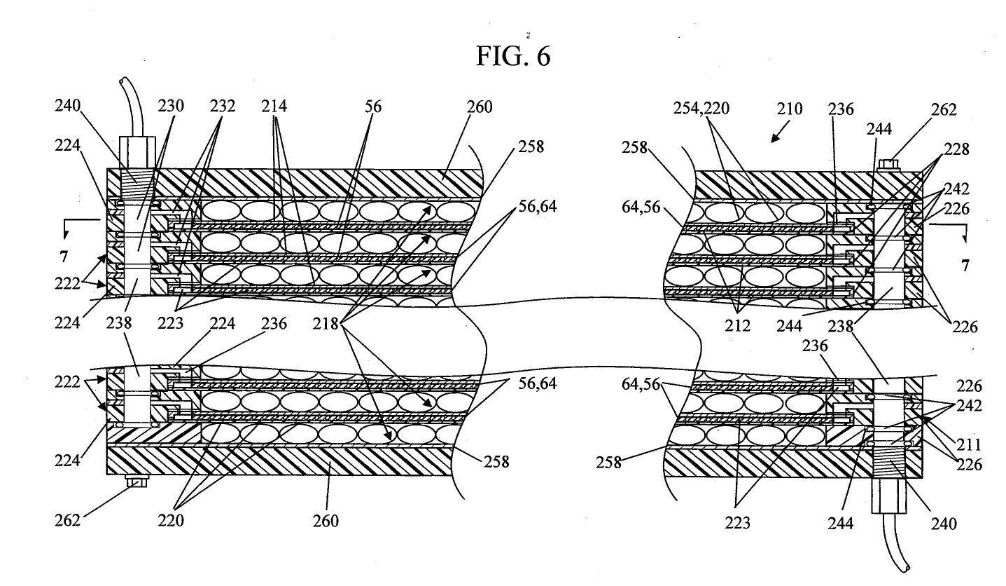

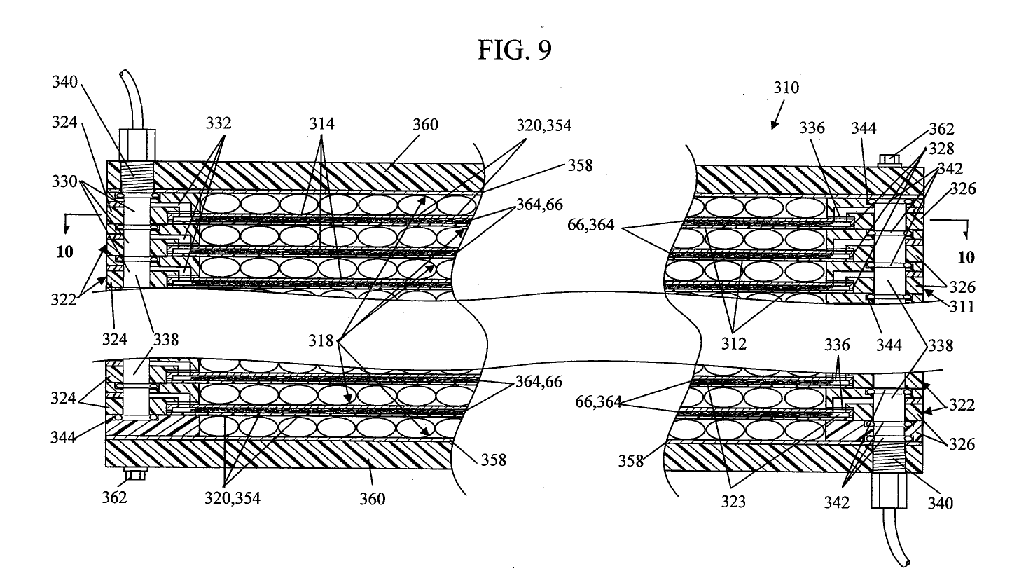

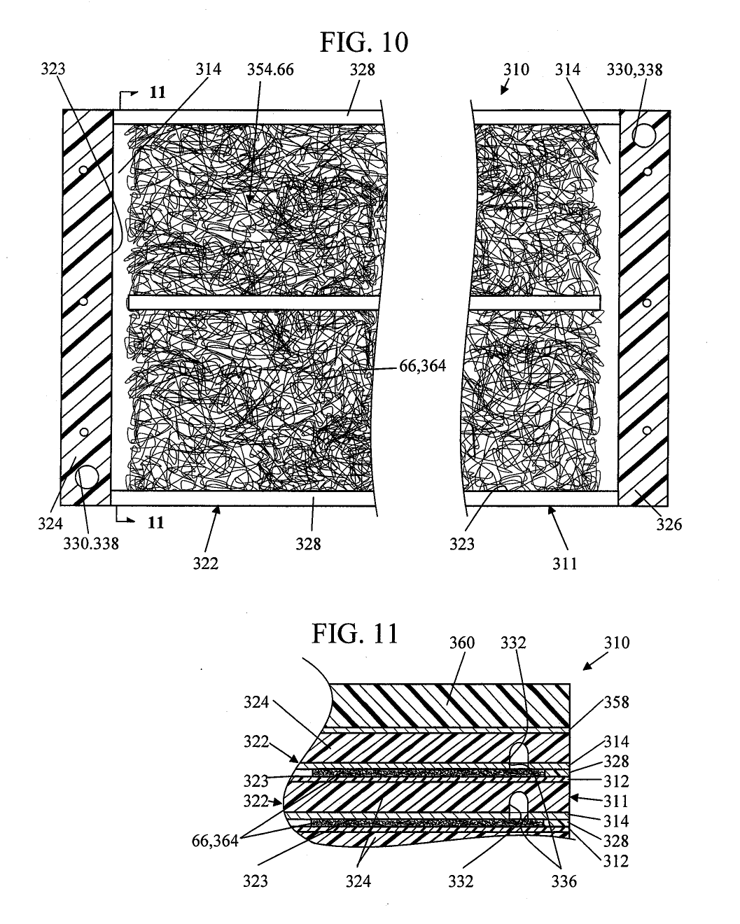

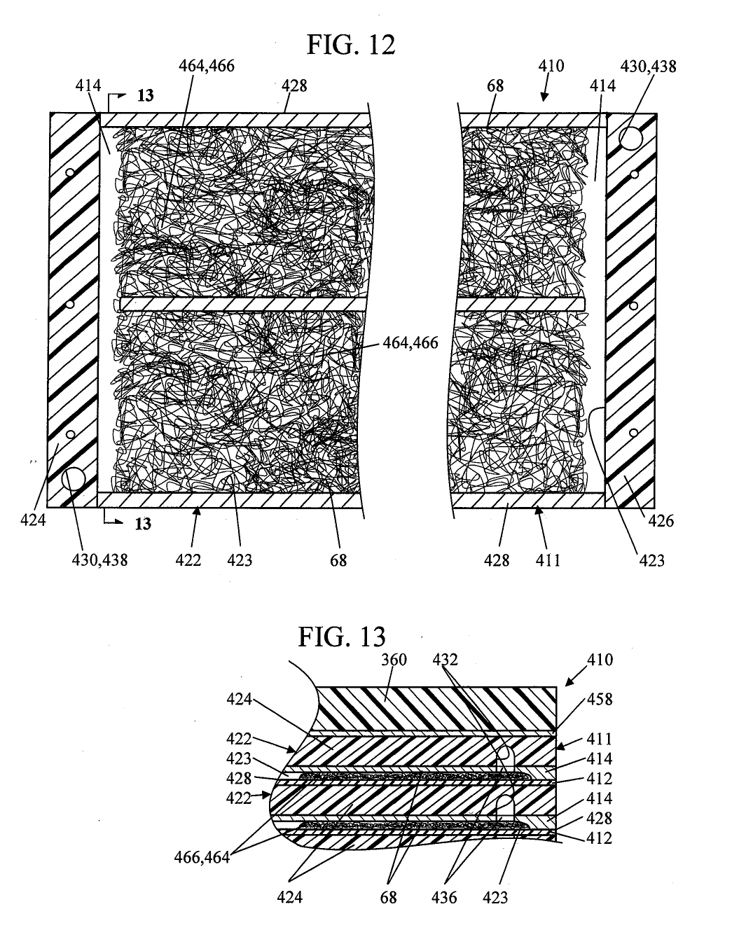

A first embodiment of a fuel cell device for generating electricity from reactant gasses such as hydrogen and oxygen is generally shown at 10 in FIGS. 1-5. A second embodiment is shown at 210 in FIGS. 6-8. A third embodiment is shown at 310 in FIGS. 9-11. A fourth embodiment is shown at 410 in FIGS. 12 and 13. Unless indicated otherwise, where a portion of the following description uses a reference numeral to refer to elements of the first embodiment shown in FIGS. 1-5, that portion of the description applies equally to elements of the second embodiment identified by the same reference numeral plus 200 in FIGS. 6-8, the elements of the third embodiment identified by the same reference numeral plus 300 in FIGS. 9-11, and elements of the fourth embodiment identified by the same reference numeral plus 400 in FIGS. 12 and 13.

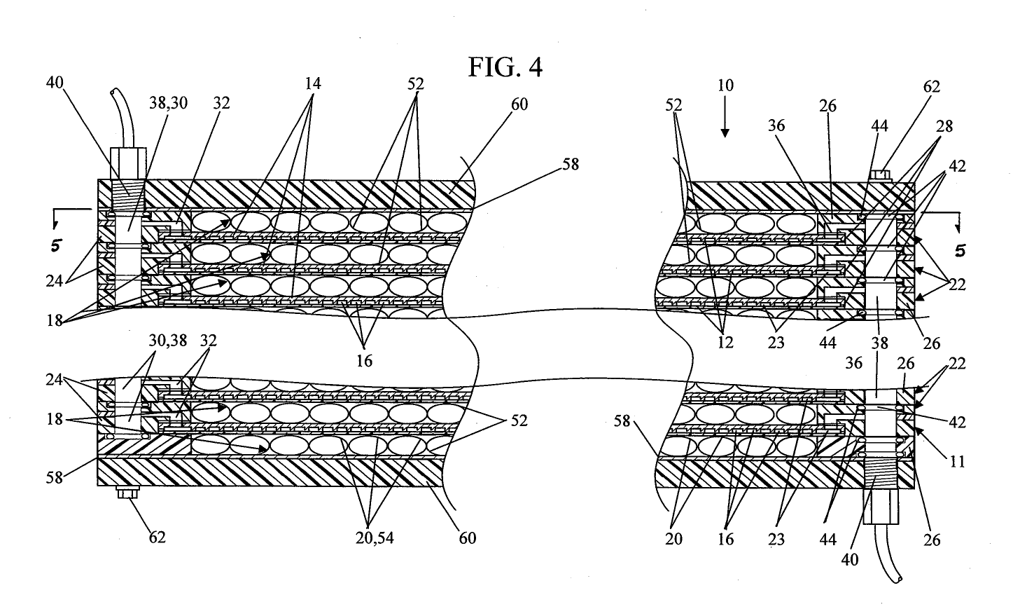

As best shown in FIG. 4 the device 10 may include a stack 11 of membrane electrode assemblies (MEAs) 12 and bipolar separator plates (BSPs) 14 supported adjacent and generally parallel to the MEAs 12. The BSPs 14 comprise a sheet or plate of conductive material such as stainless steel or graphite and include flow channels 16 that may be etched or machined into the BSPs in a reactant flow pattern to direct the flow of reactant gas across adjacent MEAs 12 as is well known in the art. The MEAs 12 may be of the polymer electrolyte variety used in Polymer Electrolyte Membrane (PEMFC) and Direct Methanol (DMFC) fuel cells. However, in other embodiments, the MEAs 12 could be of the solid oxide variety used in solid oxide (SOFC) fuel cells or the molten carbonate variety used in molten carbonate (MCFC) fuel cells. Where the MEAs 12 are of the polymer electrolyte variety, they each may include a polymer electrolyte membrane sandwiched by layers of material that may include electrode, catalyst, and gas diffusion layers as is well known in the art.

As is also best shown in FIG. 4, the device 10 may include cathode contact arrays 18 sandwiched between the MEAs 12 and the BSPs 14 on a cathode side of each MEA 12. Each such array 18 comprises a plurality of compliant electrical cathode contacts 20 providing electrical contact between the BSPs 14 and the cathode sides of the MEAs 12. The cathode contacts 20 of each cathode contact array 18 are in electrical contact with but need not be permanently attached to either the MEA 12 or the BSP 14 that the arrays 18 are sandwiched between. In other words, the cathode contacts 20 of each cathode contact array 18 may be separable or partible from and may be separably or partibly interposed between, i.e., may be in separable or partible physical contact with and may be separably or partibly engaged and retained by friction between the BSP 14 and MEA 12 that the cathode contact array 18 is sandwiched between or is in contact with.

Because the cathode contacts 20 of the cathode contact array 18 are not attached, the cathode contact array 18 can be easily installed during assembly of a fuel cell stack 11 and can also be easily removed and replaced when defective, or temporarily removed as required for fuel cell stack maintenance. Although, in the embodiment of FIG. 4 the cathode contact array 18 is shown sandwiched between MEAs 12 and BSPs 14 only on a cathode or oxygen side of each MEA 12 in a fuel cell stack 11, in other embodiments, and as described below, a contact array may be disposed on the anode or hydrogen side of each MEA 12 in a fuel cell stack 11, or contact arrays may be disposed on both the anode and cathode sides of each MEA 12 in a stack 11.

As shown in FIG. 4, each fuel cell stack 11 may include a plurality of separable or partible fuel cell modules 22 that are not only physically connected but are electrically connected in series, as well. Each such module 22 may include an MEA 12 bonded and sealed to a BSP 14 defining a gas delivery chamber 23 between the MEA 12 and the flow channels 16 of each BSP 14. Each module 22 may also include one or more gas manifolds 24, 26 that may be bonded and sealed to the BSP 14. A gas delivery chamber seal 28 that may comprise, for example, a sealant adhesive or an adhesive backed gasket, may partially define the gas delivery chamber 23 by sealing and bonding the MEA 12 and manifolds 14, 26 to the BSP 14 in each module 22. The gas manifolds 24, 26, a single one of which is shown in perspective in FIG. 3, may be identical to one another and one or both may serve as reactant gas intake manifolds in dead-ended operation, or, in circulatory operation one may serve as an intake manifold 24 and the other as an exhaust manifold 26. The gas manifolds 24, 26 each include a manifold through-hole 30 and a branching passageway 32 that carries reactant and/or purge gases to and/or from an active region or gas delivery chamber 23 defined between the MEA 12 and the BSP flow channels 16 of each module 22 on an anode side of the MEA 12.

Each BSP 14 may include two BSP through-holes 36 that allow gasses to flow between the manifold branching passageways 32 and the gas delivery chamber 23. Surrounding each such BSP through-hole 36 between the BSP 14 and the associated gas manifold 24, 26 may be an adhesive seal 35 that both adheres the gas manifolds 24, 26 of each module 22 to the BSP 14 of that module 22, and prevents reactant gas from escaping from between the gas manifold 24, 26 and the BSP 14 in regions surrounding the BSP through-holes 36.

As is also shown in FIG. 4, when the fuel cell modules 22 are stacked together, the manifold through-holes 30 are coaxially aligned and interconnected to form a trans-manifold gas passage 38 that extends through the manifolds 24, 26 of all the modules 22 in the stack 11 and that leads to a fitting or connector 40 to which a gas pressure regulator and a gas source, or a purge line may be connected. The gas manifolds 24, 26 may be sealed to one another by O-rings 42 that are placed in respective annular O-ring grooves 44 and pressed against a sealing surface on a gas manifold 24, 26 of an adjacent fuel cell module 22.

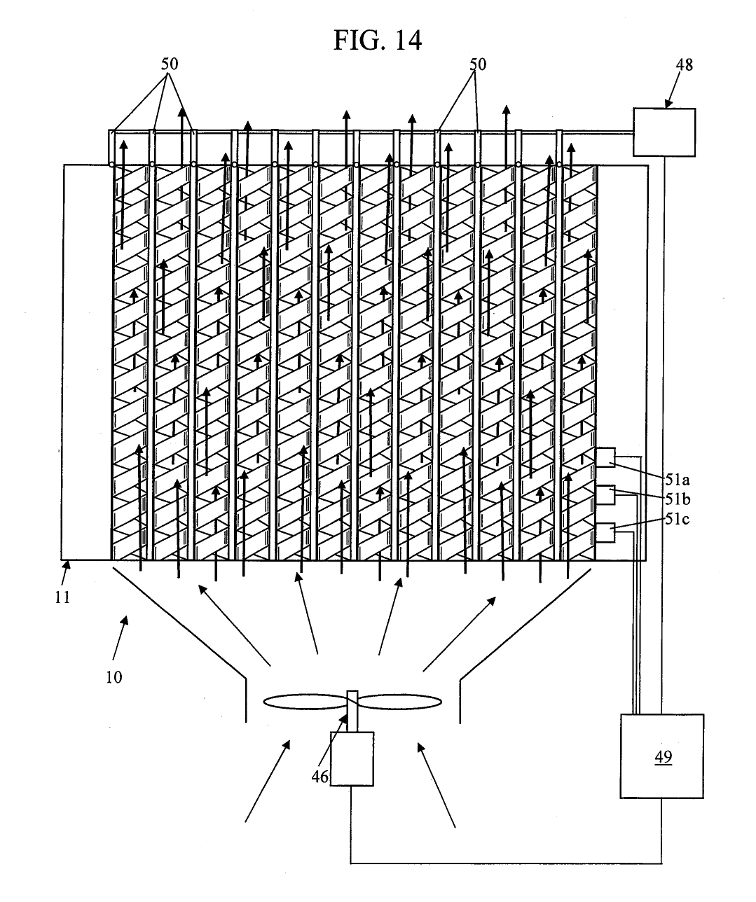

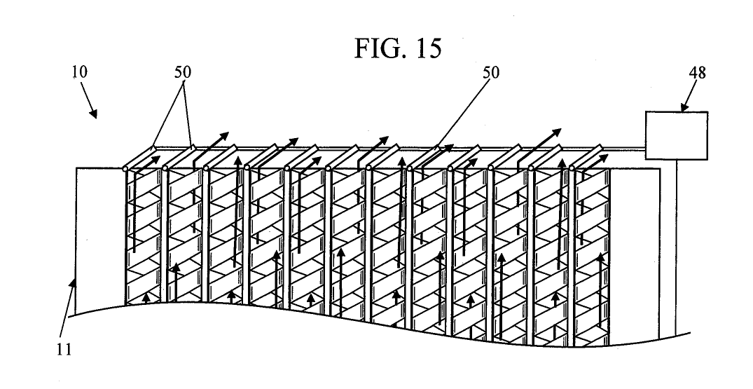

Oxygen may be provided through the convective passage of ambient air through the arrays 18 of compliant cathode contacts 20 disposed on the cathode sides of the MEAs 12 of a fuel cell stack 11, or by the forced passage of air propelled by an air propeller such as a ducted fan 46 as shown in FIG. 14 or other suitable air delivery means. Air pressure near the membranes may be increased by any suitable means to include restricting the outflow of air from the stack 11 while blowing air into the stack 11 as shown in FIG. 15. The outflow restriction may, for example, be controlled by controlling an outflow restrictor 48 that may include louvers 50 disposed across an outflow side of the fuel cell stack 11. The device 10 may include an electronic controller 49 connected to the outflow restrictor 48 and programmed to maximize power output by controlling the position of the outflow restrictor 48 in response to inputs from humidity, temperature, and/or electrical current or power sensors 51a, 51b, 51c. Humidity and temperature sensors 51a, 51b, may be supported adjacent one or more of the MEAs of the fuel cell stack and electrical current or power sensors 51c may be positioned to sense individual module current flow or power output; and/or stack current flow or power output. Outflow restricting louvers 48 are shown in a fully open position in FIG. 14 and in a partially-closed, outflow restricting position in FIG. 15. Oxygen may alternatively be provided to the cathode sides of the MEAs 12 in the form of pure oxygen or pressurized air from a pressurized air source.

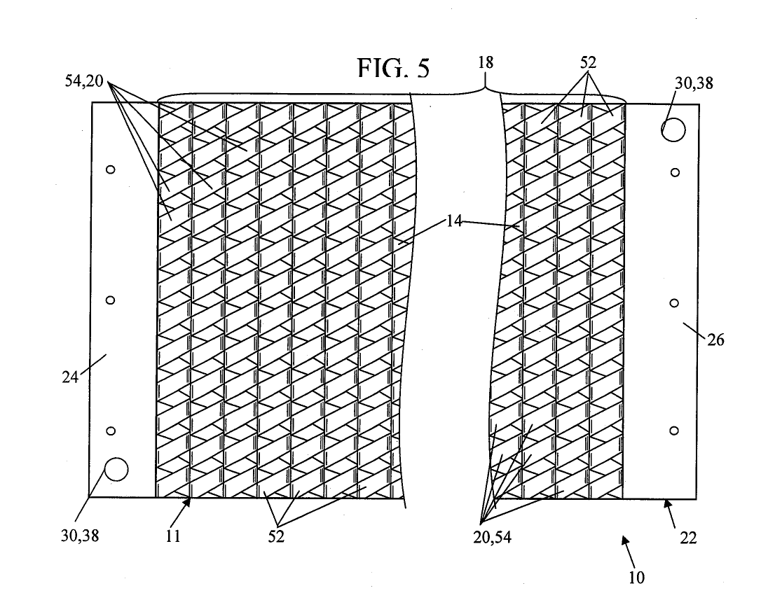

As shown in FIGS. 1, 4, and 5, each cathode contact array 18 may comprise a plurality of resilient cathode-side tubes 52. Each cathode-side tube 52 may be of any suitable cross-sectional shape and may, as best shown in FIG. 5, comprise a helix, or helically-wound electrically-conductive length of metal ribbon of generally circular or oval cross-sectional shape. Windings 54 of each helix act as a series of flexible electrical contact springs. The resilient cathode-side tubes 52 may be disposed parallel to and adjacent one-another between an MEA 12 and a BSP 14. As best shown in FIG. 5, each cathode contact array 18 may have the same approximate length and width as the MEA 12 whose cathode side the array 18 is associated with. In the depicted embodiments the cathode-side tubes 52 are partibly retained. However, in other embodiments the cathode-side tubes 52 may alternatively be connected to one, the other, or both the MEA 12 and the BSP 14 in each module 22.

Suitable resilient tubes of helically-wound metal ribbon are available from Spira Manufacturing Corporation of North Hollywood, Calif. The electrically-conductive metal ribbon comprises low cost spring temper stainless steel, which provides excellent spring memory and compression set resistance. The metal ribbon may either be electro-plated with tin (90% tin and 10% lead per AMS-P-81728) or gold.

The resilient cathode-side tubes 52 may be compressed between the cathode or oxygen side of an MEA 12 of one module 22 and the BSP 14 of another module 22 as shown in FIG. 4. Alternatively or additionally, resilient anode-side tubes 56 may be compressed between the anode or hydrogen side of an MEA 12 and the BSP 14 of the same module 22 as shown in FIGS. 6-8 and as if further discussed below with regard to the second embodiment 210. In either case, the compression of the tubes 52, 56 may optimally amount to 25% of the diameter of the tube. The force required to compress each tube 52, 56 is a function of the cube of the thickness of the stainless steel ribbon.

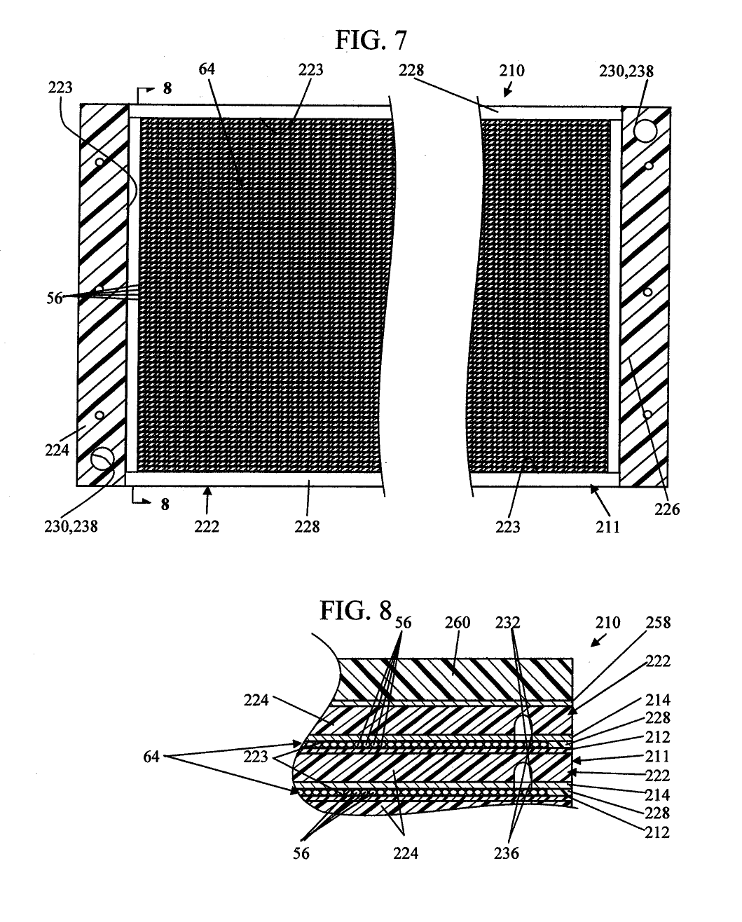

As shown in FIGS. 4 and 7, the windings 54 of the helically-wound ribbon may be spaced from each other by a helical gap extending the length of each tube. This may provide a certain amount of cyclonic or vortex motion in reactant gas passing through the tubes 52, 56. Vortex motion of reactant gas passing through cathode-side tubes 52 can increase oxygen intrusion into a gas diffusion layer of the MEAs 12 on the cathode side and, if used on the anode side, can increase hydrogen proton passage through the MEA 12 from the anode side. The increase of oxygen intrusion and/or hydrogen ion passage through the MEA 12 may be caused by a centrifugal dispersion of reactant gases through the gaps in the tubes 52, 56 towards the MEA 12. Another effect of centrifugal dispersion may be an increase in reactant gas turbulence at the MEA 12 which may occur when centrifugally-dispersed gas mixes with gas passing along and between the tubes 52, 56.

As shown in FIG. 4, two conductive current-collector layers 58 comprising, for example, sheets of metal foil, are disposed at each end of the stack 11 of fuel cell modules 22. As shown in FIG. 1, two electrodes 59 are connected to the current-collector layers 58 to allow an electrical load to be applied to the stack 11. Two non-conductive end plates 60 may cap the ends of the stack 11 and lie flush against the current-collector layers 58.

Fasteners 62 passing through the end plates 60 and manifolds 24, 26 may be tightened to compress the cathode-side tubes 52 to the point where the manifolds 24, 26 have been drawn together and lie flush with one another. The manifolds 24, 26 may be shaped and sized so that when they are drawn into a flush relationship with one another the cathode-side tubes 52 will be compressed by a desired amount, e.g., 25 percent as discussed above and as shown in FIG. 4.

The stack 11 may be oriented so that the cathode-side tubes 52 of the array 18 are oriented vertically as shown in FIG. 1. This greatly improves convective heat transfer from the stack 11, and allows the convection to improve the circulation of oxygen-bearing air to the cathode side of each fuel cell module 22 when, for example, a forced-air system, such as the one shown in FIGS. 14 and 15, is either not in use or is inoperative.

As shown in FIGS. 6-8 the second fuel cell device embodiment 210 also includes a stack 211 of fuel cell modules 222, each such module 222 including an MEA 212 and a BSP 214. This device 210 may be identical to the device 10 of the first embodiment except that it may include a second array of electrical contacts or anode contact array 64 for each fuel cell module 222. As best shown in FIGS. 6 and 8, the anode contact arrays 64 are disposed and provide electrical contact between the BSP 214 and the corresponding MEA 212 of each fuel cell module 222 of a stack 211. The anode contact arrays 64 provide electrical contact between the MEAs 212 and the BSPs 214 on an anode side of each MEA 212 in each fuel cell module 222 of the stack 211. In other words, in each module 222, the anode contact array 64 is disposed on the anode side of the MEA 212.

As with the cathode contact array 218 the anode contact array 64 of the second embodiment 210 may comprise a plurality of resilient anode-side tubes 56, each such tube 56 comprising a helix, i.e., a helically-wound electrically-conductive length of metal ribbon. The windings 54 of the helix of each anode-side tube 56 define flexible electrical contact springs along the length of each anode-side tube 56. As best shown in FIG. 7 the resilient anode-side tubes 56 of the anode contact array 64 of each module 222 are disposed generally parallel to and adjacent one-another and are compressed between the MEA 212 and the BSP 214 of each module 222.

As best shown in FIG. 7, the anode contact array 64 of each module 222 may have the same approximate length and width as the MEA 212 of that module 222 except that the anode contact array 64 is bordered by a gas delivery chamber seal 228 disposed between the outer edges of the MEA 212 and the BSP 214. According to the second embodiment 210, the chamber seal 228 may comprise a gasket and/or adhesive strips or compressed beads of adhesive that both prevent hydrogen gas from escaping the chamber 223 and space the MEA 212 from the BSP 214 sufficiently to provide room for the anode contact array 64 to be disposed within the gas delivery chamber 223. In other words, the anode contact array 64 of electrical contacts is encased in the gas delivery chamber 223 defined by the MEA 212 on one side, the BSP 214 on the other side, and a gas delivery chamber seal 228 bordering the anode contact array 64.

When hydrogen gas is introduced into the space between the anode side of an MEA 212 and an adjacent BSP 214 of a module 222, i.e., into its gas delivery chamber 223, the hydrogen may be directed to flow into the chamber 223 through one or both gas manifolds 224, 226 of the module 222 and then through and between each resilient anode-side tube 56 of the anode contact array 64. This allows the gas to contact the MEA 212, hydrogen ions to be transported through the MEA 212 toward the cathode side of the MEA 212, and electrons to travel through the anode contact array 64 to the BSP 214 of the module 222.

The resilient anode-side tubes 56 of the anode contact array 64, as with those of the first cathode contact array 18, may be helically-wound metal ribbons such as those available from Spira Manufacturing Corporation of North Hollywood, Calif. and described in detail above and in Appendix 1. They may be disposed parallel to and adjacent one-another between the MEA 212 and the BSP 214 of each module 222 as shown in FIGS. 6-8. The resilient anode-side tubes 56 are compressed between the MEA 212 and the BSP 214 of each module 22 as shown in FIGS. 6 and 8.

As with the first and second embodiments, the third embodiment 310 of FIGS. 9-11 includes a stack 311 of fuel cell modules 322, each including an MEA 312 and a BSP 314. As with the second embodiment 210 each module 322 of the third embodiment 310 includes an anode contact array 364. However, unlike the second embodiment 210 the anode contact array 364 in each module 322 according to the third embodiment 310 may comprise a mat 66 of, for example, metal strands such as stainless steel wool. In other words, one or more of the anode contact arrays 364 may comprise resilient conductive mats 66 that, as shown in FIGS. 9-11, are removably disposed between the MEAs 312 and BSPs 314 of each module 322. The mats 66 may comprise metal material such as interwoven or intermeshed or tangled metal strands such as stainless steel wool or open-celled metal foam or sponge material. Such mats 66 would both provide electrical current flow between the BSPs 314 and the anode sides of the MEAs 312, and would at the same time allow for the passage of reactant gas.

Alternatively, or additionally, and according to the fourth embodiment shown in FIGS. 12 and 13, the gas delivery chambers 423 of each module 422 may include a recess 68 formed in the BSP 414 of each module 422. As is best shown in FIG. 13, such recesses 68 provide additional headroom for contact arrays 464 disposed within the gas delivery chambers of the stacked modules 422 and may preclude the need to include gaskets or sealing strips between the BSPs 414 and the anode sides of the MEAs 414 of each module 422.

Such a fuel cell device 10 can be made by first providing a plurality of MEAs 12 and BSPs 14, and connecting, i.e., sealing and adhering the MEAs 12 to respective BSPs 14 and the BSPs to respective gas manifolds 24, 26 to form fuel cell modules 22. If an anode contact array 264, 364 is to be included in each module 222, 322 then in constructing each module a chamber seal 28, 328 is adhered and sealed to the BSP 214, 314 the array 264, 364 is disposed on the BSP within a perimeter defined by the chamber seal 28, 328; and the MEA is sealed and adhered to the chamber seal. Alternatively, rather than, or in addition to using chamber seals, recesses 68 may be formed in the BSPs 414 of each module 422 to form gas delivery chambers 423, and the anode contact arrays 464 positioned within the recesses 68 before adhering the MEAs 412 to the BSPs 414.

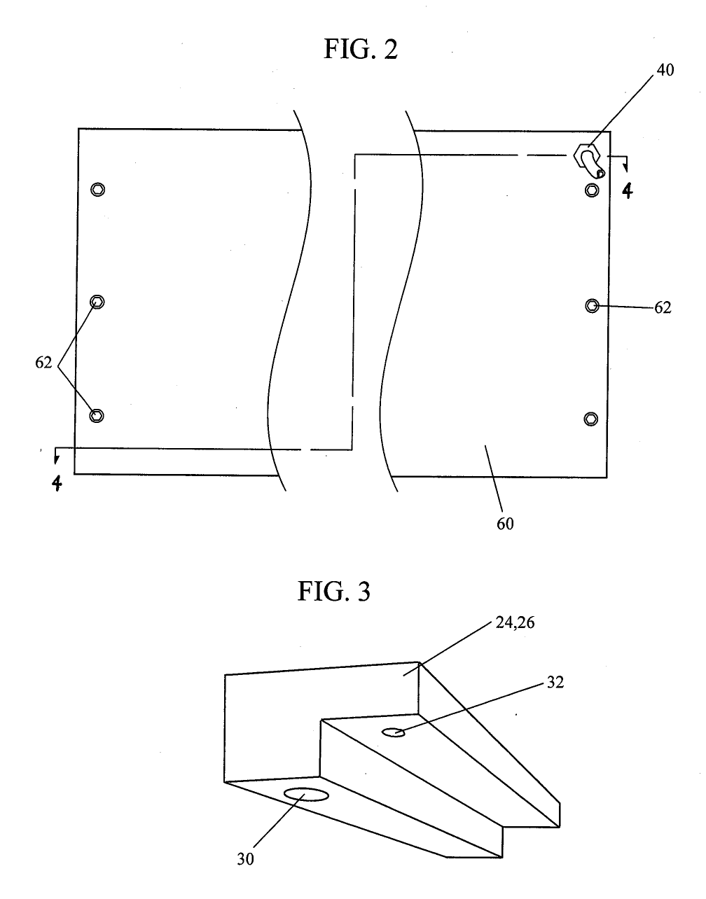

Once the fuel cell modules 22 have been formed, the stack 11 may then be assembled by removably sandwiching resilient contact arrays 18 between the fuel cell modules 22 such that each resilient contact array 18 is disposed and provides electrical contact between the MEA 12 of one fuel cell module 22 and the BSP 14 of an adjacent fuel cell module 22 as shown in FIGS. 2 and 8.

The cathode contact arrays 18 may be sandwiched between modules 22 one at a time by first supporting a first cathode contact array 18 either on the MEA 12 or on the separator plate of a first one of the fuel cell modules 22. A second fuel cell module 22 may then be supported on the first cathode contact array 18 such that, if the MEA 12 of the first fuel cell module 22 is supporting and contacting the first cathode contact array 18, then the BSP 14 of the second fuel cell module 22 is placed in contact with the first cathode contact array 18. Conversely, if the BSP 14 of the first fuel cell module 22 is supporting and contacting the first cathode contact array 18, then the MEA 12 of the second fuel cell module 22 is placed in contact with the first cathode contact array 18. This procedure is then repeated for the remainder of the contact arrays 18 and modules 22. The cathode contact arrays 18 may then compressed between the modules 22 as shown in FIGS. 3 and 8 by inserting and tightening fasteners 62 between the end plates 60 and through the gas manifolds 24, 26.

In sandwiching the cathode contact arrays 18 between the fuel cell modules 22, where each cathode contact array 18 comprises a plurality of resilient cathode-side tubes 52 comprising helically-wound electrically-conductive lengths of metal ribbon, the cathode-side tubes 52 may be spaced carefully apart or simply disposed in a loose side-by-side arrangement as shown in FIG. 4 as the stack is being assembled and before the arrays 18 are compressed. The cathode-side tubes 52 may be spaced far enough apart or placed loosely enough so as to leave sufficient room for the cathode-side tubes 52 to expand radially when compressed between the modules 22 as best shown in FIG. 9.

The use of compliant electrical cathode contact arrays 18 and the adhesive sealing of MEAs 12 obviates the need for high compression forces to be applied to the stack 11, and, consequently, the need for thick BSPs 14 and precise parallelism between the plates in a stack 11. Where graphite BSPs 14 are used, the vastly reduced stack compressive forces preclude BSP breakage and high scrap rates associated with the manufacture of fuel cell stacks incorporating graphite BSPs 14. Only enough compressive force is required to compress the electrical cathode contact arrays 18 to the point where the fuel cell modules 22 are seated together, with the manifolds 24, 26 providing proper spacing between BSPs 14. Compliant electrical anode contact arrays 64 allow for the use of gas delivery chambers in place of reactant gas channels 16 in BSPs 14 on the anode sides of MEAs 12. Because the contact arrays 18, 64 may be partibly retained between the BSPs 14 and MEAs 12 they may simply be laid in place during stack assembly rather than attached to the BSPs in advance. Accordingly, the use of compliant partibly retained electrical cathode contact arrays 18 can greatly speed and ease the manufacture of fuel cell stacks.

This description is intended to illustrate certain embodiments of the invention rather than to limit the invention. Therefore, it uses descriptive rather than limiting words. Obviously, it's possible to modify this invention from what the description teaches. Within the scope of the claims, one may practice the invention other than as described.

I claim:

1. A fuel cell device (10) for generating electricity from hydrogen and oxygen, the device comprising:
a membrane electrode assembly (12);
a bipolar separator plate (14) supported adjacent and generally parallel to the membrane electrode assembly;
a contact array (18, 64) comprising a plurality of compliant electrical contacts (20) partibly retained and providing electrical contact between the membrane electrode assembly and the bipolar separator plate.

2. The fuel cell device (10) of claim 1 in which the contact array (18, 64) comprises a plurality of electrically-conductive resilient tubes (52, 56).

3. The fuel cell device (10) of claim 2 in which each tube (52, 56) comprises a helically-wound electrically-conductive length of metal ribbon.

4. The fuel cell device (10) of claim 1 in which the contact array (364) comprises an integral conductive mat (66) that is removably disposed between the membrane electrode assembly (312) and the bipolar separator plate (314).

5. The fuel cell device (10) of claim 1 in which:
the device (10) includes a stack (11) of fuel cell modules (22), each module including a membrane electrode assembly (12) and a bipolar separator plate (14); and
the device includes a cathode contact array (18) of compliant electrical contacts (20) disposed and providing electrical contact between the bipolar separator plate of one fuel cell module (22) and the membrane electrode assembly of an adjacent fuel cell module of the stack (11).

6. The fuel cell device (10) of claim 5 in which the device (210) includes an anode contact array (64) of compliant electrical contacts disposed and providing electrical contact between the bipolar separator plate (214) and the membrane electrode assembly (212) of the same fuel cell module (222).

7. The fuel cell device (10) of claim 6 in which the anode contact array (64) comprises a plurality of electrically-conductive resilient anode-side tubes (256).

8. The fuel cell device (10) of claim 7 in which each resilient anode-side tube (256) of the anode contact array of each module (222) comprises a helically-wound electrically-conductive length of metal ribbon.

9. The fuel cell device (10) of claim 6 in which the anode contact array (64) is encased in a gas delivery chamber (223) defined by a chamber seal (228) bordering the anode contact array and sandwiched between the bipolar separator plate (214) and the membrane electrode assembly (212) of each module (222), the chamber seal being configured to prevent hydrogen gas from escaping the gas delivery chamber (223).

10. The fuel cell device (10) of claim 9 in which the gas delivery chamber (423) of each module (422) includes a recess (68) formed in the bipolar separator plate (414) of each module.

11. The fuel cell device (10) of claim 1 in which the device (10) includes a propeller positioned to move air through the device (10) between the bipolar separator plate (14) and a cathode side of the membrane electrode assembly (12), and an outflow restrictor (48) disposed in a position on an outflow side of the device and operable to variably restrict the outflow of air from the device.

12. The fuel cell device (10) of claim 11 in which the device (10) includes an electronic controller (50) connected to the outflow restrictor (48) and programmed to maximize power output by controlling the position of the outflow restrictor (48) in response to inputs from one or more sensors (51) selected from the group including humidity, temperature, electrical current, and electrical power sensors.

13. A fuel cell device (10) for generating electricity from hydrogen and oxygen, the device comprising:
a membrane electrode assembly (12);
a bipolar separator plate (14) supported adjacent and generally parallel to the membrane electrode assembly; and
a contact array (18, 64) comprising a plurality of electrically-conductive resilient tubes (52, 56) disposed and providing electrical contact between the membrane electrode assembly and the bipolar separator plate.

14. The fuel cell device (10) of claim 13 in which each tube (52, 56) comprises a helically-wound electrically-conductive length of metal ribbon.

15. The fuel cell device (10) of claim 1 in which in which:
the device (10) includes a stack (11) of fuel cell modules (22) that each include a membrane electrode assembly (12) and a bipolar separator plate (14); and
a cathode contact array (18) of resilient cathode-side tubes (52) provides electrical contact between the bipolar separator plate (14) of one fuel cell module and the membrane electrode assembly of an adjacent fuel cell module.

16. A method for making a fuel cell, the method including the steps of:
providing a membrane electrode assembly (12) and a bipolar separator plate (14); and
partibly retaining a resilient contact array (18) between the membrane electrode assembly (12) and the bipolar separator plate (14).

17. The method of claim 16 in which:
the step of providing a membrane electrode assembly (12) and a bipolar separator plate (14) includes providing a plurality of membrane electrode assemblies and bipolar separator plates and connecting each of the membrane electrode assemblies to one of the bipolar separator plates to form a plurality of fuel cell modules (22); and
the step of partibly retaining includes removably sandwiching each resilient contact array (18) between two fuel cell modules such that each resilient contact array is disposed and provides electrical contact between the membrane electrode assembly (12) of one fuel cell module (22) and the bipolar separator plate (14) of an adjacent fuel cell module.

18. The method of claim 16 in which:
the step of removably sandwiching each resilient contact array (18) between two fuel cell modules (22) includes:
supporting a resilient contact array on one fuel cell module; and
supporting another fuel cell module on the resilient contact array.

19. The method of claim 16 in which the step of partibly retaining a resilient contact array (18) between the membrane electrode assembly (12) and the bipolar separator plate (14) includes arranging a plurality of resilient tubes (52) between the membrane electrode assembly and the bipolar separator plate.

20. The method of claim 16 in which the step of arranging a plurality of resilient tubes (52) includes providing a plurality of tubes that each comprise a helically-wound, electrically-conductive length of metal ribbon.
